(19) United States
(12) Patent Application Publication
(10) Pub. No.: US 2001/0021921 A1
(43) Pub. Date: Sep. 13, 2001

(54) Customer service method and system

(76) Inventors: Masayuki Kan, Yokohama (JP); Koichi Kunimasa, Ebina (JP); Kyoji Chiba, Hadano (JP); Takahiro Tsukishima, Zushi (JP)

Correspondence Address: Mattingly, Stanger & Malur, P.C, 104 East Hume Avenue, Alexandria, VA, 22301, US

(21) Appl. No.: 09/800,568

(22) Filed: Mar. 8, 2001

(30) Foreign Application Priority Data
Mar. 10, 2000 (JP) 00-067549

(51) Int. Cl. G06F 17/60

(52) U.S. Cl. 705/27

(57) ABSTRACT

The invention builds a system having a server to store customer/product information and offer customer service/information to users, user products, and a network for connecting the user products to the server. In order that the server obtains user information and offers high grade service to product users, the products to be sold are prepared in condition that the data for connecting to the server is stored and the software for connecting to the server and initiating the dialog between the product and the server is installed. This software starts to run as soon as the product is powered on and the transaction for registering user/customer information with the server smoothly begins.

After user/customer information is registered, a customer's private web page is created and linked to the product web page. When the server is notified that the customer purchased another product, the server links the web page for the product newly purchased by the customer to the customer's private web page. The server offers the information and service for kinds of products via a single customer's private web page, thereby enhancing the service to the customer/user.

### BACKGROUND OF THE INVENTION

The present invention relates to a customer service method, particularly to a system making it possible that product-by-product discrete information is prepared and linked to customer information, based on which customer information service and maintenance service are offered.

Suppliers' practice of obtaining customer information required for offering customer information service and maintenance service, which has been generally applied heretofore in the industry, is as follows: after dealers sell a supplier's products as commodities to customers, the supplier obtains the information about the customers via the dealers or the customers who purchased a supplier's product return a postcard supplied with the product to the supplier. With the advance of electronic business, on the other hand, electronic commerce systems have lately been built in which suppliers sell their products as commodities directly to customers without the intervention of dealers. It becomes more important for the suppliers of products to obtain the information about end users/customers, properly manage and actively use such information, and offer sufficient service to the customers.

With regard to the above-mentioned suppliers' practice of obtaining customer information via dealers or by having the customers returned a postcard, however, there is some difficulty of obtaining such information as the postcard return rate is not high. Sufficient means for suppliers to obtain information about customers who directly purchased their products as commodities by electronic commerce without the intervention of dealers have not been known.

### SUMMARY OF THE INVENTION

An object of the present invention is to make it possible that the supplier of products, after selling their products, obtains the information about the end users of the products, regardless of whether or not a dealer intervenes, properly manages such information, and offers higher grade service to the product users, thus solving the above-mentioned difficulty of obtaining customer information.

The present invention achieves this goal as follows:

The invention builds a system comprising a server to store customer/product information and offer customer service/information to users, user products, and a network for connecting the user products to the server. The products to be sold are prepared in condition that the data for connecting to the server to offer customer service/product information is stored and the software for connecting to the server and initiating the dialog between the product and the server is installed. This software starts to run as soon as the product is powered on and the transaction for registering user/customer information with the server smoothly begins.

After user/customer information is registered, a customer's private web page is created and linked to the product web page. When the server is notified that the customer purchased another product, the server links the web page for the product newly purchased by the customer to the customer's private web page. In this way, the server offers the information and service for kinds of products via a single customer's private web page, thereby enhancing the service to the customer/user.

Furthermore, the present invention enables product guarantee service offering even if the user/customer has lost the product's guarantee certificate unless the term of guarantee is expired or reliable maintenance service offering even for a customer who purchased a used article of the supplier's product line.

### BRIEF DESCRIPTION OF THE DRAWINGS

FIG. 1 is a block diagram showing a customer service system configured as a preferred embodiment of the present invention.

FIGS. 2A and 2B are schematic representations outlining the owner registration procedure whereby a customer who purchased a product is registered as the owner of the product.

FIGS. 3A and 3B are schematic representations outlining the registration removal procedure whereby a customer who purchased a product removes the owner registration of the product and the owner registration procedure whereby a customer who gets the product later is registered as the owner of the product.

FIGS. 4A and 4B are schematic representations outlining another example of the product owner registration procedure.

FIGS. 5A and 5B are schematic representations outlining another example of the registration removal procedure whereby a customer who purchased a product removes the owner registration of the product and the owner registration procedure whereby a customer who gets the product later is registered as the owner of the product.

FIG. 6 is a flowchart illustrating the detailed procedure of the registration transaction for service use whereby a customer who purchased a product is registered as the owner of the product.

FIG. 7 is a flowchart illustrating the detailed procedure to be carried out when the customer uses offered service after the customer is registered for service use.

FIG. 8 is a flowchart illustrating the detailed procedure to be carried out when the customer cancels the customer information service after the customer is registered for service use.

FIG. 9 is a flowchart illustrating another example of the detailed procedure to be carried out when the customer uses offered service after the customer is registered for service use.

FIG. 10 is a flowchart illustrating another example of the detailed procedure to be carried out when the customer uses offered service after the customer is registered for service use.

FIG. 11 is a flowchart illustrating another example of the detailed procedure to be carried out when the customer cancels the customer information service after the customer is registered for service use.

FIG. 12 and FIG. 13 in combination show a flowchart illustrating the detailed procedure of the product owner registration for customer service use, wherein the customer may get the product from someone else or in a dishonest manner.

### DETAILED DESCRIPTION OF THE PREFERRED EMBODIMENTS

A preferred embodiment of the customer service method of the present invention will now be described in detail.

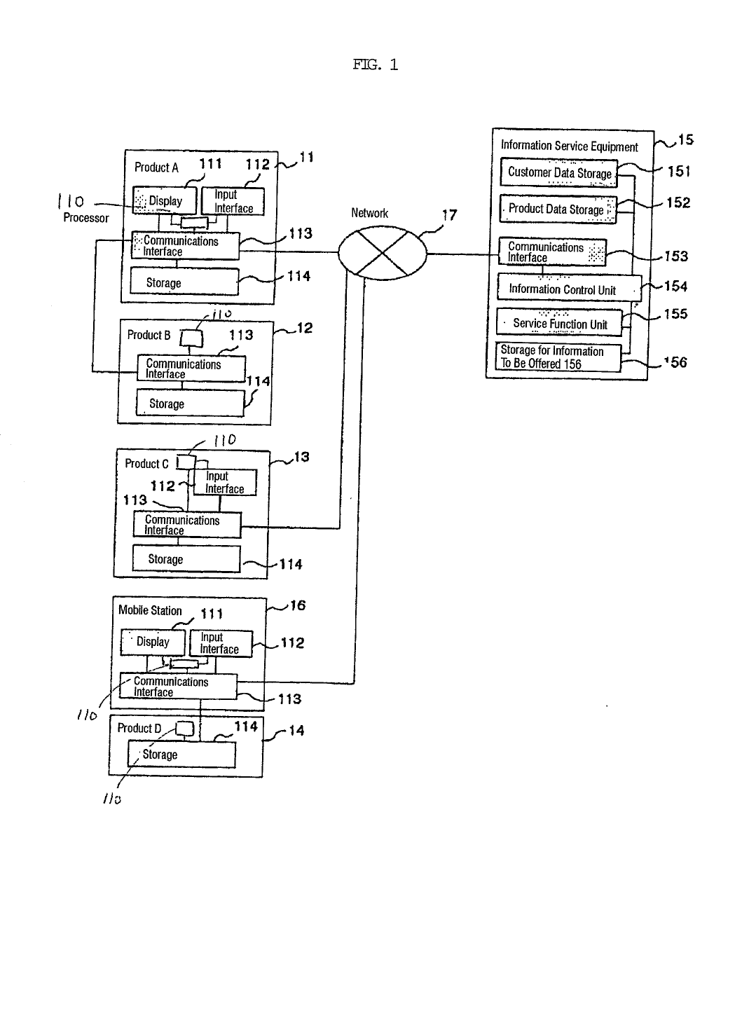

FIG. 1 is a block diagram showing a system configuration for implementing the customer service method, according to a preferred embodiment of the present invention. Main entities constituting the customer service system shown in FIG. 1 are customer products A to D labeled 11 to 14, respectively, information service equipment labeled 15, and a mobile station labeled 16 with a network 17 for interconnecting them. Other entities are a processor 110, a display 111, an input interface 112, communications interfaces 113 and 153, storage 114, customer data storage 151, product data storage 152, information control unit 154, service function unit 155, and storage for information to be offered 156.

In the customer service system shown in FIG. 1, the products A 11 to D14 are customer-purchased product examples and have at least the storage into which their product number (including product type) has been registered in advance. The product A 11, shown as the product example, comprising the processor 110, display 11, input interface 112, communications interface 113, and storage 114 is, for example, a personal computer (PC), television equipped with a touch panel as the input interface feature, etc. The processor 110 reads software stored in the storage 114 and executes software-controlled information processing. The display 111 displays data to give the user of the product visible information. The input interface 112 allows the user to input data required for information processing. The communications interface 113 controls data communication over the network.

The storage 114 is to retain, in addition to the product number, the data for connecting to a discrete product web page whereon the information for the product is offered (such as, for example, telephone number and page address) and the authentication data for connection such as a user password for accessing the product web page. Of such data to be stored into the storage, at least the data for connecting to the product web page is to be per-stored into the storage before the customer purchases the product and starts to operate it.

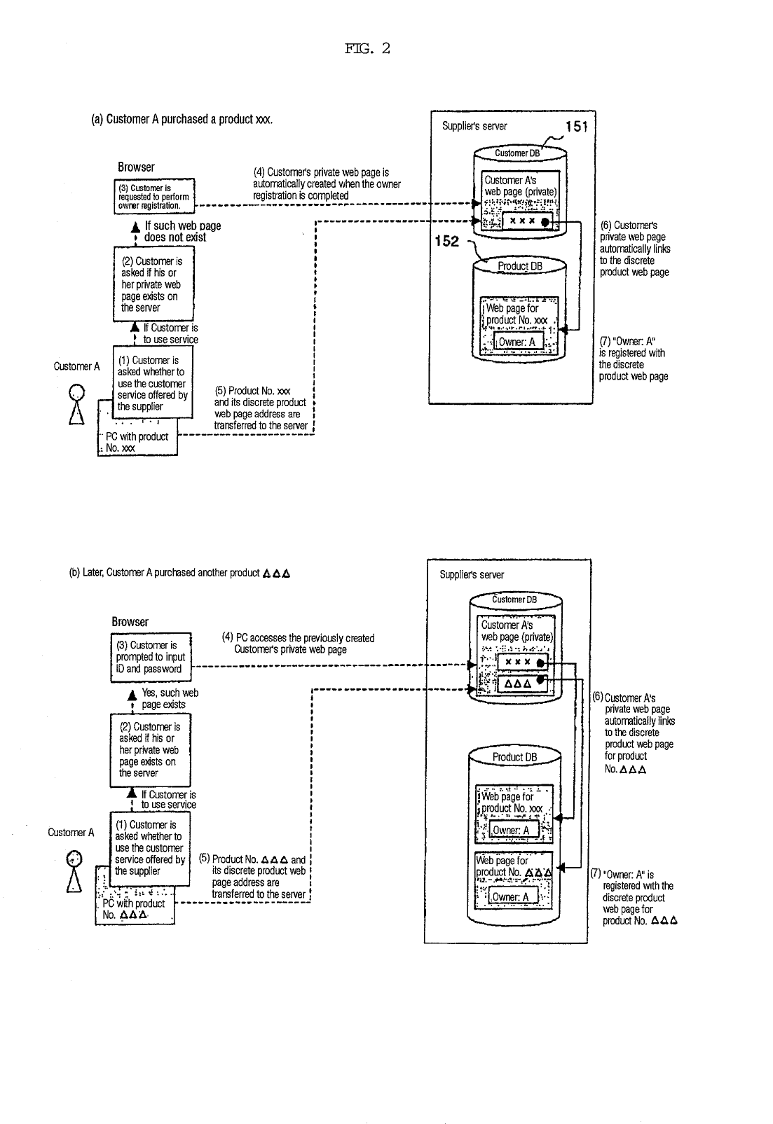

Furthermore, the storage 114 is to retain the software required for client-side transactions, for example, displaying a dialog window that guides the user in the user registration procedure as soon as the product is powered on, which will be described later with reference to FIG. 2 and subsequent drawings. Such software is also to be pre-stored into the storage before the customer purchases the product and starts to operate it. The processor 110 reads and executes the software in the storage 114.

The product D 14 is an product example comprising the processor 110 and storage 114 does not have the input interface 112 and display 111 as the user interface and the communications interface 113. This product is connected to another product such as a mobile station equipped with the input interface 112, display 111, and communications interface 113, so that the contents of its storage 114 are read through the mobile station. The product B 12 is an product example comprising the processor 110, storage 114, and communications interface 113. This product is connected to the communications interface of another product such as product A, so that the contents of its storage 114 are delivered to the product such as product A via the communications interfaces 113. The product C 13 is a product example equipped with the communications 113 interface that controls its connection to the network as well as the input interface 112. The product D is, for example, a household electrical appliance, a unit of gas fittings, etc. that is furnished with at least the storage 114 out of the input interface 112, communication interface 113, and storage 114 for implementing the present invention.

The mobile station 16 is well-known equipment furnished with the display 11, input interface 112, and communications interface 113 and used to transmit the product number data of the product D114 that is equipped with only the storage 114 to the information service equipment 15 and receive the offered service information for such product. Equipment to be used by the customer, including the above-mentioned products, will be referred to as a general term, customer-side equipment, hereinafter. As implied from the above description, the customer-side equipment is classified into products comprising the processor, storage, communications interface, display, and input interface; products equipped with at least the storage out of these components; and devices equipped with any functional unit of the communications interface, display, and input interfaces that the above second devices do not have.

Of these products thus classified, some products equipped with the communications interface 113 and the input interface 112 in addition to the storage 114 can connect to the information service equipment 15 that is a proprietary of the product supplier via a public communications line such as Internet by using their communications interface 113, so that they can send their product number data to the information service equipment 15 and receive the offered service information.

The information service equipment 15 is configured as part of the server system architecture of the product supplier; it comprises the customer data storage 151, product data storage 152, communications interface 153, information control unit 154, service function unit 155, and storage for information to be offered 156. The information service equipment 15 creates a web page per customer for managing individual information for the customer, as requested by the customer who owns a product and wants information service offered, and stores a great number of customer-by-customer-basis web pages thus created as a customer database (DB) into the customer data storage 151. The product data storage 152 is to retain a great number of product web pages created on the PN (product number) by PN basis in the supplier's product line as a product DB.

The service function unit 155 executes the function of offering kinds of information services for customer-owned products. The storage for information to be offered 156 is to retain kinds of information that can be offered to the customers. The information control unit 154 controls the information service equipment 15 as a whole and also controls the following: obtaining customer information from the user equipment connected over the communication interface 153, offering information to the customers, and product information service implementation. The information to be offered may include, for example, instruction manuals per product, fault information, version-up information, maintenance information, precaution information, coming new production introduction, discount information beneficial for the customers who accessed the system.

Of the information service equipment 15, the customer data storage 151, product data storage 152, storage for information to be offered 156 are functional divisions on storage comprising, for example, hard disks. The information control unit 154 and the service function unit 155 are functional divisions of the process to be implemented as the processor executes the programs thereof installed in the main storage.

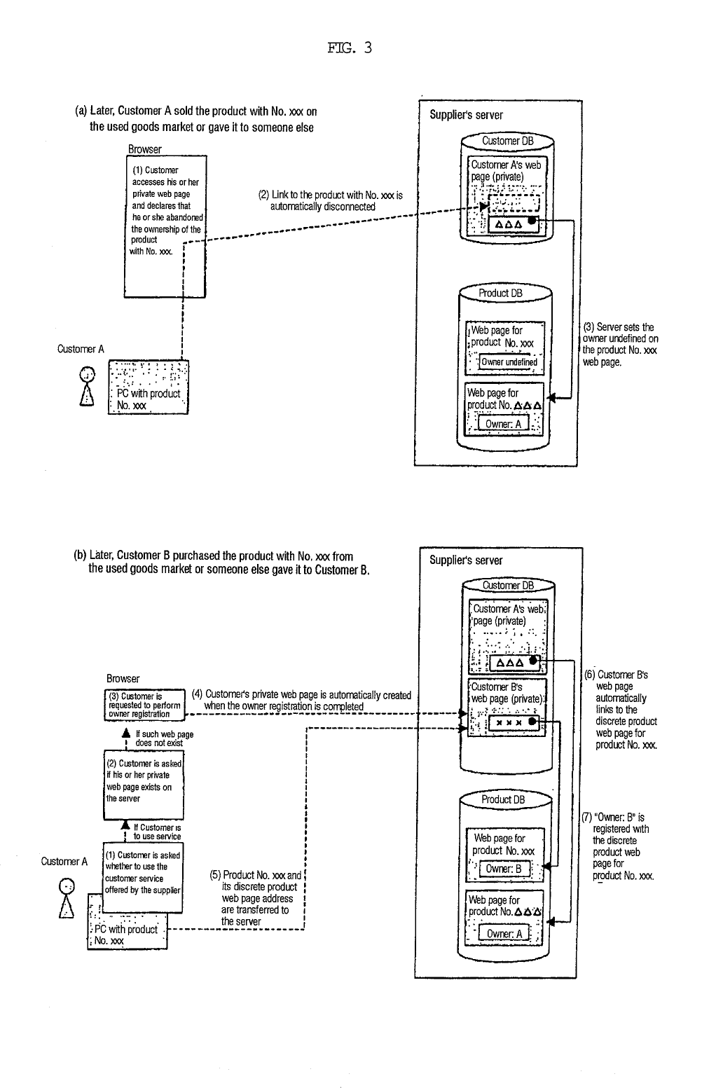

FIGS. 2A, 2B, 3A and 3B are schematic representations for explaining the product owner registration procedure and the registration removal procedure to be carried out between the customer who purchased a product and the supplier-proprietary information service equipment 15 in the customer service system configured as described above to embody the present invention. With reference to these drawings, the outlines of the product owner registration procedure and the registration removal procedure will be explained below. In example cases shown in FIGS. 2 and 3, the product is assumed to be a PC and thus the user-proprietary product comprises the processor 110, display 111, input interface 112, communications interface 113, and storage 114 as explained with reference to FIG. 1.

FIG. 2A is a schematic process representation of a case where Customer A who purchased a PC carries out the PC owner registration. When Customer A turns the power switch on of the PC, the product he or she purchased, the PC software asks the user whether to use the customer service offered by the supplier (1). If the Customer answers “Yes” which means that he or she wants the customer service offered, the PC software asks the user whether the Customer's private web page exists on the server, created at the previous purchase of another product of the supplier (2). If the Customer answers “No” which means that such web page does not exist, the PC software requests the user to perform the PC owner registration (3). When the user accepts the request and inputs his or her name, address, ID, and password to the PC, the PC software executes owner registration and creates the Customer's private web page for the user (4). Then, the PC accesses the information service equipment 15, explained with reference to FIG. 1, under the supplier's server and has the Customer A's private web page stored into the customer data storage 151 as the customer DB. Then, the PC transfers the product No. “XXXX” pre-recorded in the PC's storage or the address of the product web page for that product No. in the product DB to the supplier's server (5). The supplier's server registers the product No. “XXXX” transferred from the PC with the Customer A's private web page in the customer DB and links the Customer A's private web page to the discrete product web page for the product No. “XXXX” in the product DB (6). Then, the supplier's server registers “Owner A” with that product web page in the product DB (7).

In this way, Customer A can perform the owner registration of the PC that he or she purchased. Steps (1) to (5) of the above procedure are carried out by interaction between Customer A and the functional parts of the PC as shown in FIG. 1 and steps (6) and (7) are carried out on the supplier's server. In the above procedure, the Customer may input his or her physical characteristic feature information such as his or her fingerprint instead of the password input for authentication.

FIG. 2B is a schematic process representation of a case where Customer A purchased another product later, a different PC of the same supplier, and carries out the owner registration of the newly purchased PC after he or she previously completed the owner registration by the procedure in FIG. 2A. Similarly also in this case, when Customer A turns the power switch on of the PC, the product he or she purchased, the same procedure is carried out as the above-mentioned steps (1) and (2) and the Customer is asked whether the Customer's private web page exists on the server, created at the previous purchase of another product of the supplier. When the Customer answers “Yes” which means that such web page exists on the server, the PC software requests the user to input ID and password (3). When the user inputs ID and password, the PC accesses the information service equipment 15 under the supplier's server and accesses the previously created Customer's A private web page existing in the customer data storage 151 as the customer DB. Then, the PC transfers the product No. “ΔΔΔΔ” pre-recorded in the PC's storage or the address of the product web page for that product No. in the product DB to the supplier's server (5). The supplier's server registers the product No. “ΔΔΔΔ” transferred from the PC with the Customer A's private web page in the customer DB and links the Customer A's private web page to the discrete product web page for the product No. “ΔΔΔΔ” in the product DB (6). Then, the supplier's server registers “Owner A” with that product web page in the product DB (7).

In this way, Customer A can perform the owner registration of the second PC that he or she purchased. After the above procedure, the two PC products' numbers are now registered with the Customer A's private web page and “Owner A” is registered with two discrete products' web pages. If one customer has registered on the server as the owner of a plurality of products as in this example, the information service equipment may change the grade of the service to be offered to the customer; for example, by setting an increased discount rate to apply when the customer will purchase another product of the supplier.

FIG. 3A is a schematic process representation of a case where Customer A removes the owner registration executed by the procedure in FIG. 2A after selling the PC with product No. “XXXX” that he or she previously purchased on the used goods market or after giving it to someone else.

In this case, Customer A who was the owner of the PC with product No. “XXXX” accesses his or her private web page on the supplier's server and declares that he or she abandoned the ownership of the product with No. “XXXX” (1). Then, the supplier's server deletes the product No. “XXXX” from the Customer A's private web page, disconnects the link to the discrete product web page for product No. “XXXX” in the product DB (2), and sets the owner “undefined” on the above product web page.

FIG. 3B is a schematic process representation of a case where Customer B purchased the product (PC) with No. “XXXX” sold by Customer A on the used goods market or became its owner by being given from Customer A and carries out the PC owner registration. The owner registration procedure in this case is the same as described in FIG. 2A. A new Customer B's private web page is created in the customer DB on the supplier's server and “Owner B” is registered with the discrete product page for product No. “XXXX” in the product DB. In this case, owner change can be recorded as the owner history record on the discrete product web page and the grade of the service to be offered can be changed, based on this owner history information.

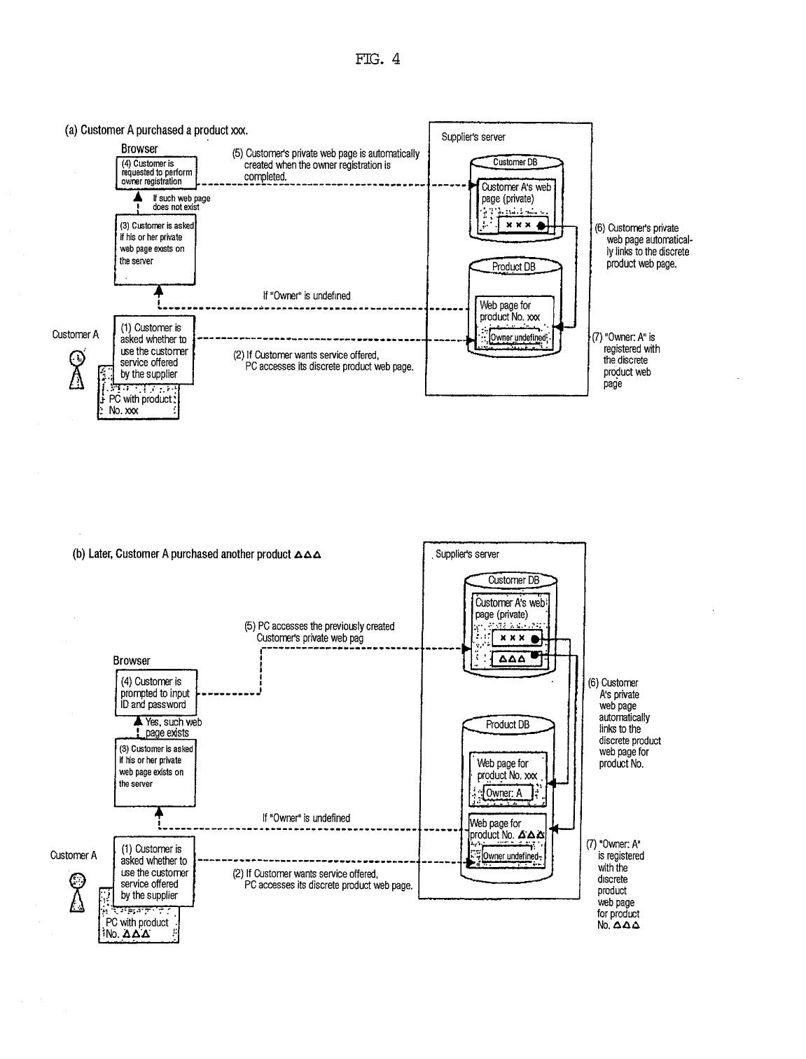

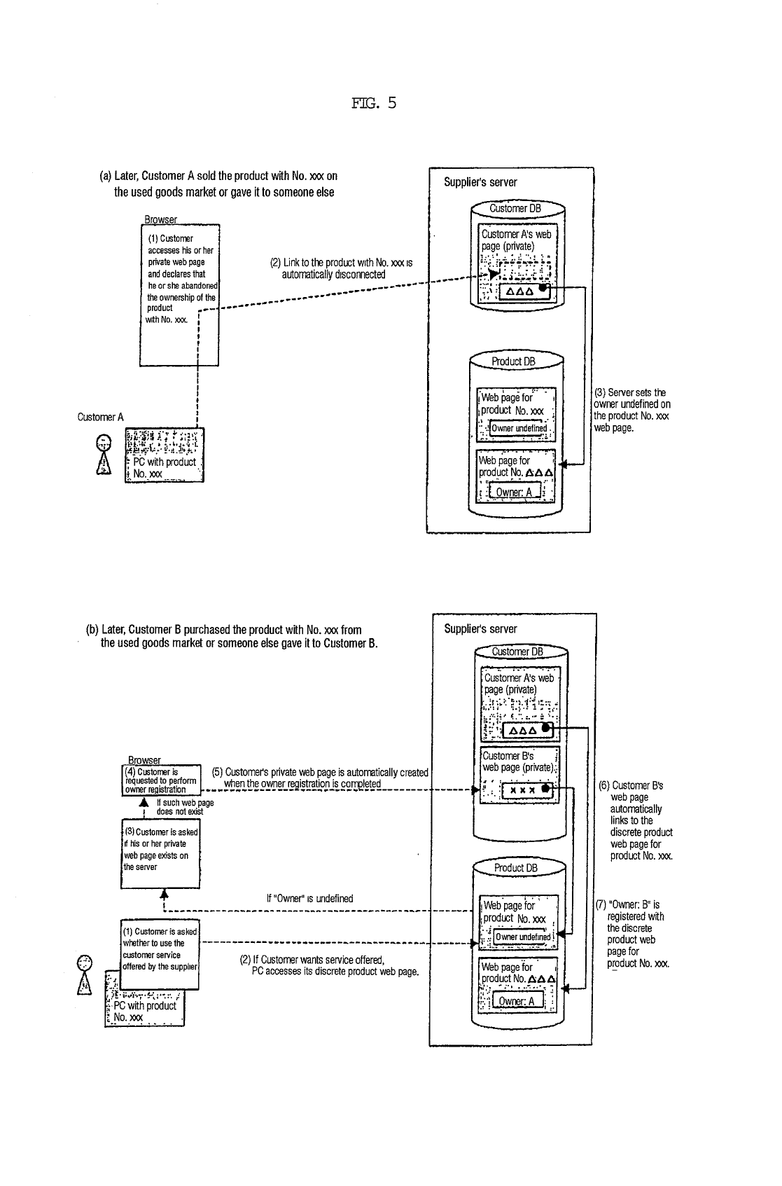

FIG. 4 and FIG. 5 are schematic representations for explaining another example of the product owner registration procedure and the registration removal procedure to be carried out between the customer who purchased a product and the supplier-proprietary information service equipment 15. With reference to these drawings, the outlines of the product owner registration procedure and the registration removal procedure will be explained below. In example cases shown in FIGS. 4 and 5, similarly, the product is assumed to be a PC as is the case with FIGS. 2 and 3.

The procedures illustrated in FIG. 4A, FIG. 4B, FIG. 5A, and FIG. 5B correspond to the procedures illustrated in FIG. 2A, FIG. 2B, FIG. 3A, and FIG. 3B and the former are the same as the latter except for some difference. Difference of the owner registration procedures illustrated in FIGS. 4A, 4B, and 5B from those illustrated in FIGS. 2A, 2B, and 3B is as follows. In step (1), after the PC software asks the user whether to use the customer service offered by the supplier, if the Customer answers “Yes” which means that he or she wants the customer service offered, the PC accesses the discrete product web page on the supplier's server (2), based on the product number pre-recorded in the PC's storage or the address of the product web page for that product number in the product DB. If the owner of that product is undefined, the owner registration procedure goes to the next step. Other processing is executed in the same way as illustrated in FIGS. 2 and 3. The procedure for owner registration removal illustrated in FIG. 5A is the same as illustrated in FIG. 3A.

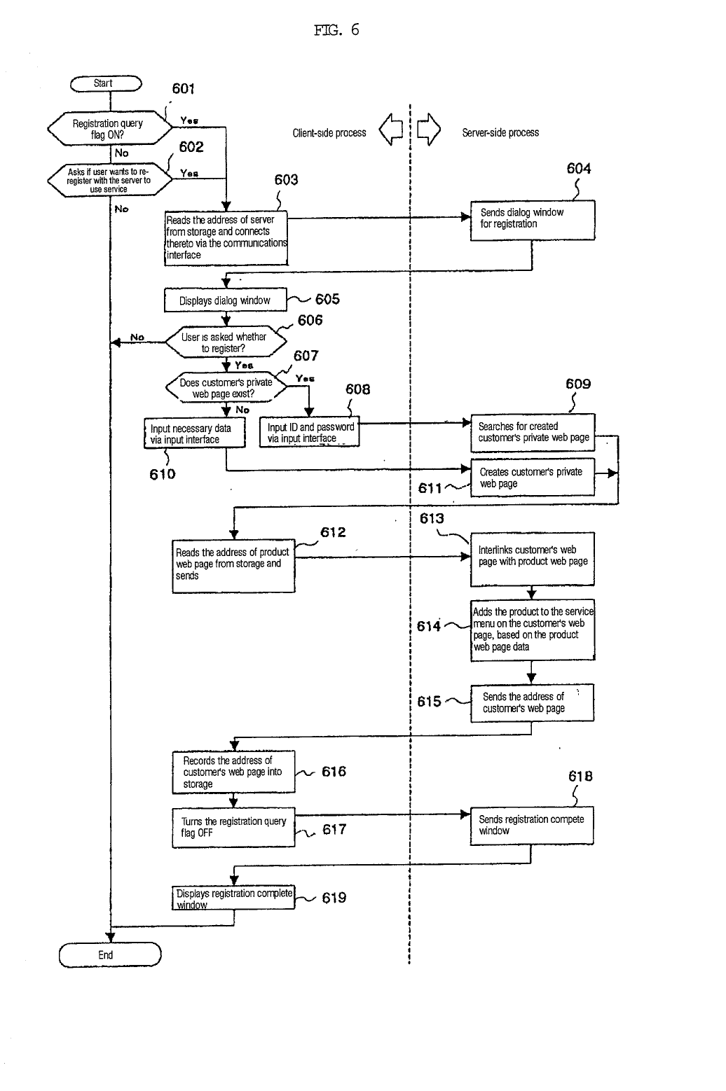

FIG. 6 is a flowchart illustrating the detailed procedure of the product owner registration transaction for service use to be carried out between the customer who purchased a product and the supplier-proprietary information service equipment 15. This procedure will be explained below. The client-side process is the customer/user transaction and the server-side process is carried out by the information service equipment under the supplier's server, which is true for other procedure flowcharts which will appear later. The processor 110 of one of the products A to D executes the software stored in the storage 114, thereby processing the user transaction. The information control unit and the service function unit of the above equipment are responsible for executing the server-side process. In the flowcharts following FIG. 6, the processor or the information control unit reads and executes the programs stored in the server-side and/or the client-side storage to implement the function.

(1) When the product is powered on, the product checks to see whether its internal registration query flag is ON (step 601). If the flag is not ON, the product asks if the user wants to re-register with the server to use service (step 602). If the user rejects the re-registration for service use, then the transaction terminates. The above registration query flag is programmed as set ON into the software of the product and turned OFF upon the completion of the registration transaction after the product is initially powered on by the user who purchase the product.

(2) If the flag is ON at the check in the step 601 or if the user requests re-registration for service use in the step 602, from the product's storage, its processor reads the address of server on which the product must be registered for service use and is going to connect thereto via the communications interface (step 603).

(3) When the connection to the information service equipment is established, the information service equipment sends the dialog window for registration to the user equipment whereon this window is displayed on its display screen (steps 604 and 605). On the dialog window, the user is asked whether to register with server to use service (step 606). If the user rejects the registration for service use, then the transaction terminates.

(4) If the user requests registration for service use in the step 606, the user is asked whether the user's private web page exists on the server (step 607). If the user answer “Yes, ” the user is prompted to input the user ID and password via the input interface (step 608). The server-side information service equipment searches the customer DB for the previously created customer's private web page (step 609).

(5) If the user answers “No” in the step 607, which means the customer's private web page does not exist on the server, the user is prompted to input necessary data such as. for example, user name, address, ID, and password via the input interface (step 610). The server-side information service equipment creates a customer's private web page and stores it into the customer DB (step 611).

(6) From the product's storage, its processor reads the address of the discrete product web page, sends it to the server, and accesses the product web page (step 612). Then, the server-side equipment interlinks the customer's private web page with the discrete product web page (step 613).

(7) The server-side equipment adds the product to the service menu on the customer's private web page, based on the discrete product web page data (step 614), and sends the address of the customer's private web page to the user equipment (step 615).

(8) The user equipment records the address of the customer's private web page into its storage (step 616) and turns the registration query flag OFF (step 617) if the registration transaction was initiated by the ON of the registration query flag.

(9) The server-side equipment sends the registration complete window to the user equipment whereon this window is displayed on its display screen screen, when the transaction terminates (steps 618 and 619).

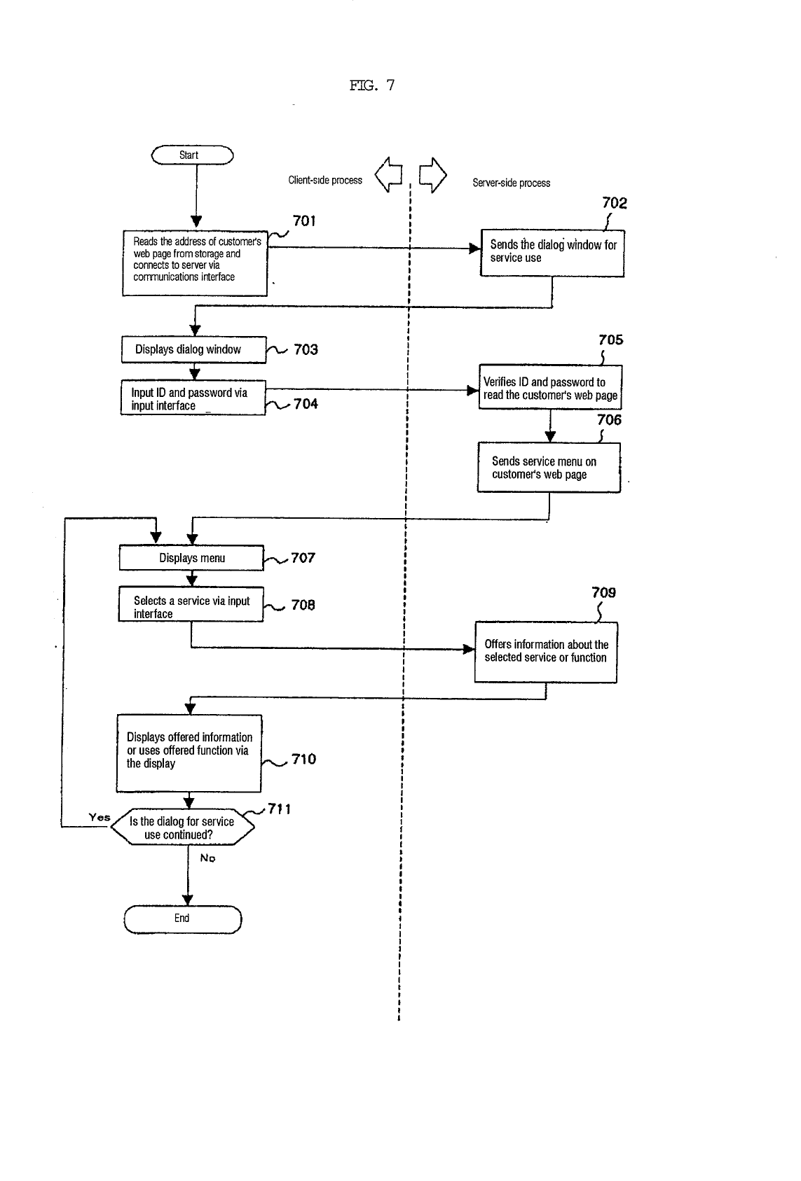

FIG. 7 is a flowchart illustrating the detailed procedure to be carried out when the customer uses offered service after the customer is registered for service use. This procedure will be explained below.

(1) The user equipment reads from its storage the address of the customer's private web page and connects to the server-side equipment via the communications interface (step 701). Then, the server-side equipment sends the dialog window for service use to the user equipment whereon this window is displayed on its display screen (steps 702 and 703).

(2) The user inputs ID and password via the input interface as prompted on the displayed dialog window (step 704). The server-side equipment verifies the customer ID and password that has been sent from the user side to read the customer's private web page (step 705). Once having verified the ID and password, the server-side equipment sends the service menu form the customer's private web page (step 706).

(3) The user equipment displays the service menu on its display screen (step 707). When the user selects a desired service from the menu, this information is sent to the server-side equipment (step 708). The server-side equipment sends back the information about the selected service or the information required for offering the requested function to the user equipment (steps 709).

(4) The user equipment displays the offered information or the information required for offering the function received from the server on its display screen, so that the user may use the offered information and function (step 710). The user is asked whether you want to continue the dialog to select another service (step 711). If the user answer “Yes,” the service menu reappears as in the step 707, and the user can continue the transaction for service request. If the user answer “No,” this transaction terminates.

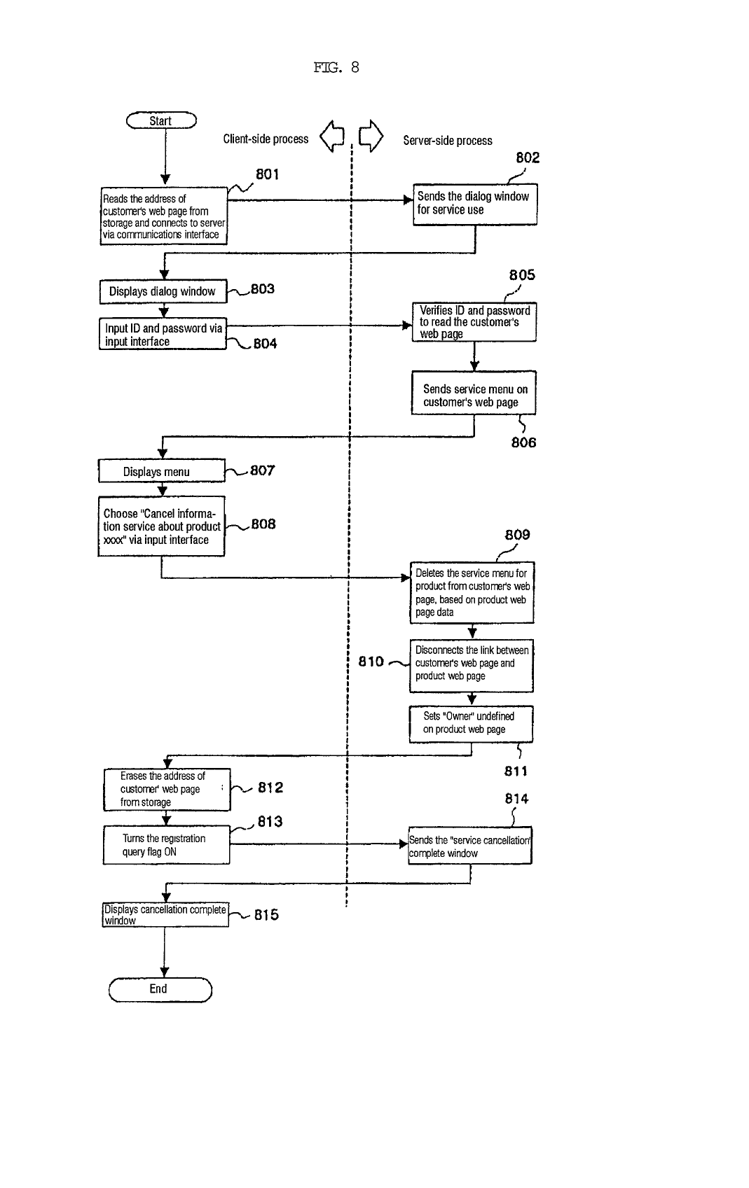

FIG. 8 is a flowchart illustrating the detailed procedure to be carried out when the customer cancels the customer information service after the customer is registered for service use. This procedure will be explained below.

(1) From the initial step where the user equipment reads from its storage the address of the customer's private web page and connects to the server-side equipment via the communications interface, up to the step where the server-side equipment sends the service menu from the customer's private web page to the user equipment whereon the service menu is displayed on the its display, the procedure is the same as explained in the steps 701 to 707 in FIG. 7 (steps 801 to 807).

(2) From the displayed menu, the user shall choose “Cancel information service about product XXXX” (step 808). This information is sent to the server-side equipment. The server-side equipment deletes the service menu for the product from the customer's private web page, based on the discrete product page data (step 809).

(3) The server-side equipment disconnects the link between the customer's private web page and the discrete product web page and sets “Owner” undefined on the product web page (steps 810 and 811).

(4) If the product for which the customer wants information service canceled is at hand, the user equipment erases the address of the customer's private web page from the product's storage and turns the registration query flag ON (steps 812 and 813).

(5) The server-side equipment sends the service cancellation complete window to the user equipment whereon this window is displayed on the its display, when the service cancellation transaction terminates (steps 814 and 815).

If the product for which the customer wants information service canceled is not at hand, the above information service cancellation transaction can also be executed by the access from another customer-owned product to the server. In this case, however, it is not possible to erase the address of the customer's private web page from the product's storage in the step 812 and turn the registration query flag ON in the step 813.

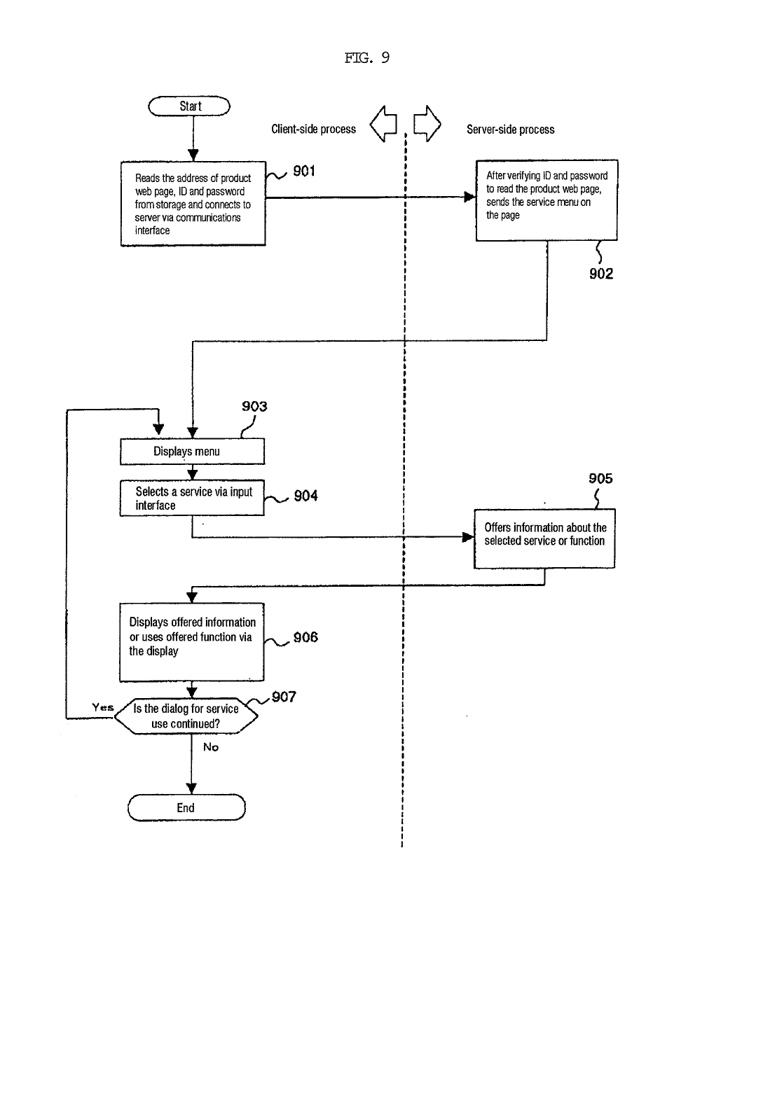

FIG. 9 is a flowchart illustrating the detailed procedure to be carried out when the customer requests product information service to use offered service, regardless of whether or not the customer performs the registration transaction for service use. This procedure will be explained below.

(1) The user equipment reads from its storage the address of the discrete product web page, product ID and password, connects to the server-side equipment via its communication interfaces, and sends the ID and password to the server-side equipment (step 901).

(2) The server-side equipment verifies the product ID and password that has been sent from the user side to read the discrete product web page. Once having verified the ID and password, the server-side equipment sends the service menu on the discrete product web page (step 902).

(3) Then, the same transaction is performed as explained in the steps 707 to 711 in FIG. 7: i.e., the service menu is displayed on the user on its display screen; the user selects and uses a desired service; and the transaction terminates when the user quits the dialog (steps 903 to 907).

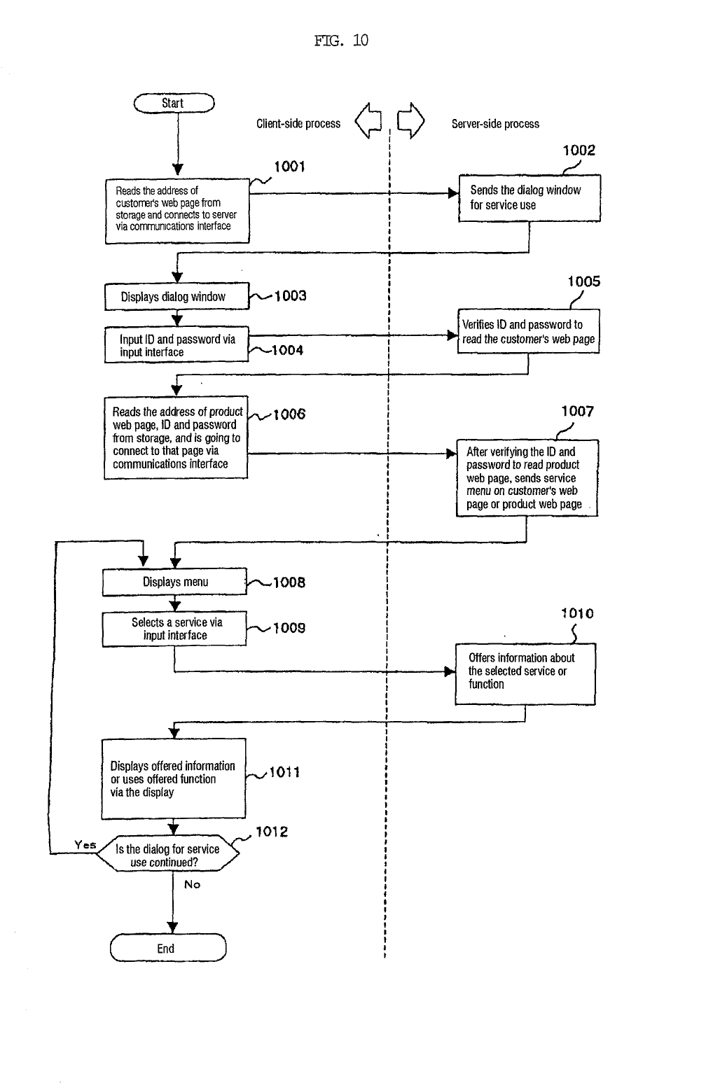

FIG. 10 is a flowchart illustrating another example of the detailed procedure to be carried out when the customer uses offered service after the customer is registered for service use. This procedure will be explained below.

(1) First, the same transaction between the user side and the supplier side is performed as explained in the steps 701 to 705 in FIG. 7: i.e., the user equipment connects to the server-side equipment via its communications interface; and the server-side equipment verifies the customer ID and password that has been sent from the user side to read the customer's private web page (steps 1001 to 1005).

(2) Once the server-side equipment has verified the ID and password, the user-side equipment reads from its storage the address of the discrete product web page, product ID and password to read that page, and is going to connect to that page (step 1006).

(3) The server-side equipment verifies the product ID and password that has been sent from the user side to read the discrete product web page. Once having verified the ID and password, the server-side equipment sends the service menu on the customer's private web page or the discrete product web page to the user equipment (step 1007).

(4) Then, the same transaction is performed as explained in the steps 707 to 711 in FIG. 7: i.e., the service menu is displayed on the user on its display screen; the user selects and uses a desired service; and the transaction terminates when the user quits the dialog (steps 1008 to 1012). In the transaction explained above with reference to FIG. 10, the supplier's server verifies both the user/customer ID and product ID and offers service. Thus, the supplier can make sure that the product is actually used each time the user requests service use, thereby monitoring the use rate of their products.

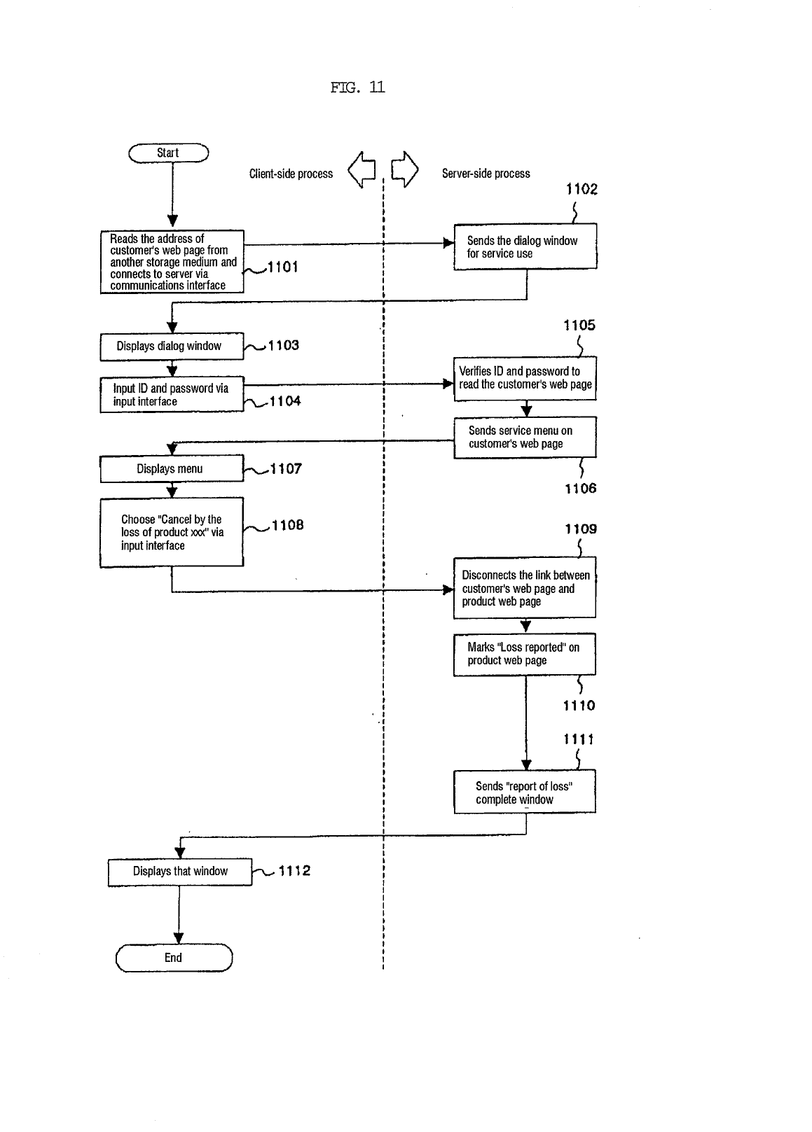

FIG. 11 is a flowchart illustrating another example of the detailed procedure to be carried out when the customer cancels the customer information service after the customer is registered for service use. In this example, such a case is assumed that the customer's product was stolen and the customer cancels the information service offering for the product as well as notifying the server of the loss of the product. This procedure will be explained below.

(1) Because of the loss of the product whose information service is to be offered, the user uses another storage medium, for example, the storage of another product that the user owns. This product, namely, the user equipment reads the address of the customer's private web page from its storage and connects to the server-side equipment via its communications interface (step 1101).

(2) The subsequent transaction is performed in the same way as explained in the steps 702 to 707 in FIG. 7 and the server-side equipment sends the service menu on the customer's private web page to the user equipment where the menu is displayed on its display screen (steps 1102 to 1107).

(3) The user shall choose “Cancel by the loss of product XXXX” from the displayed menu (step 1108). This information is sent to the server-side equipment. The server-side equipment disconnects the link between the customer's private web page and the discrete product web page (steps 1109).

(4) The server-side equipment marks “Loss reported” on the product web page and sends the “report of loss” complete window to the user equipment (steps 1110 and 1111). The user equipment displays the received window on its display screen, when the transaction terminates (step 1112).

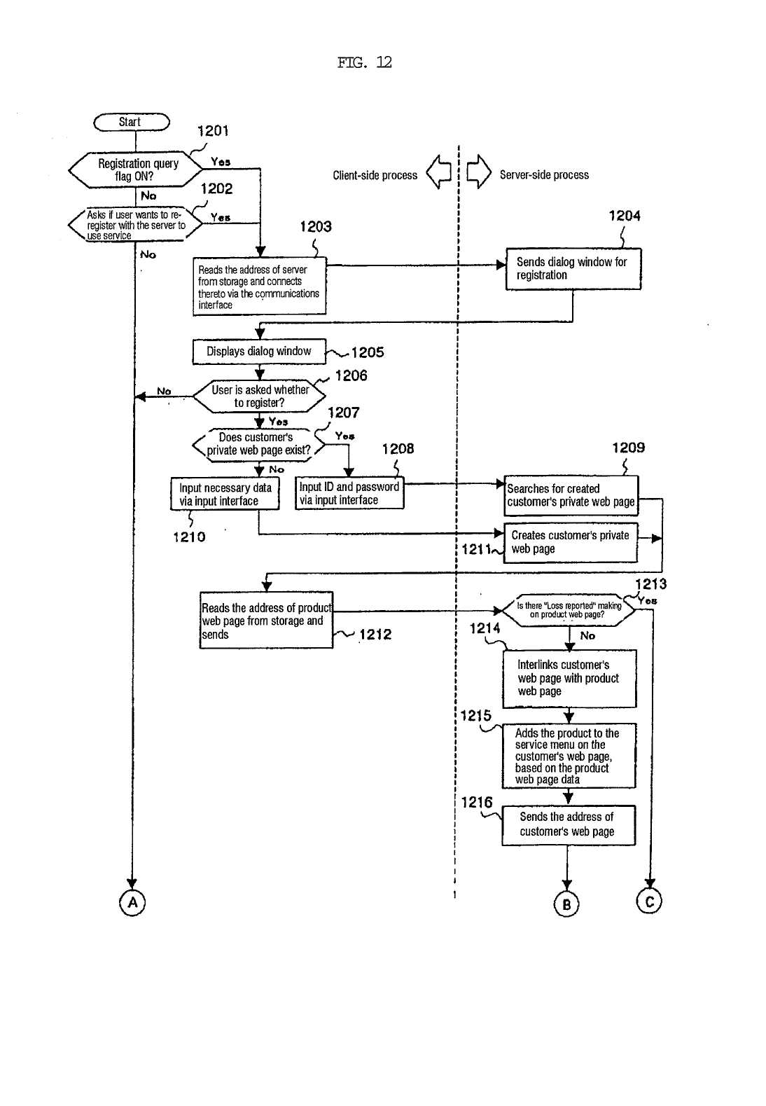

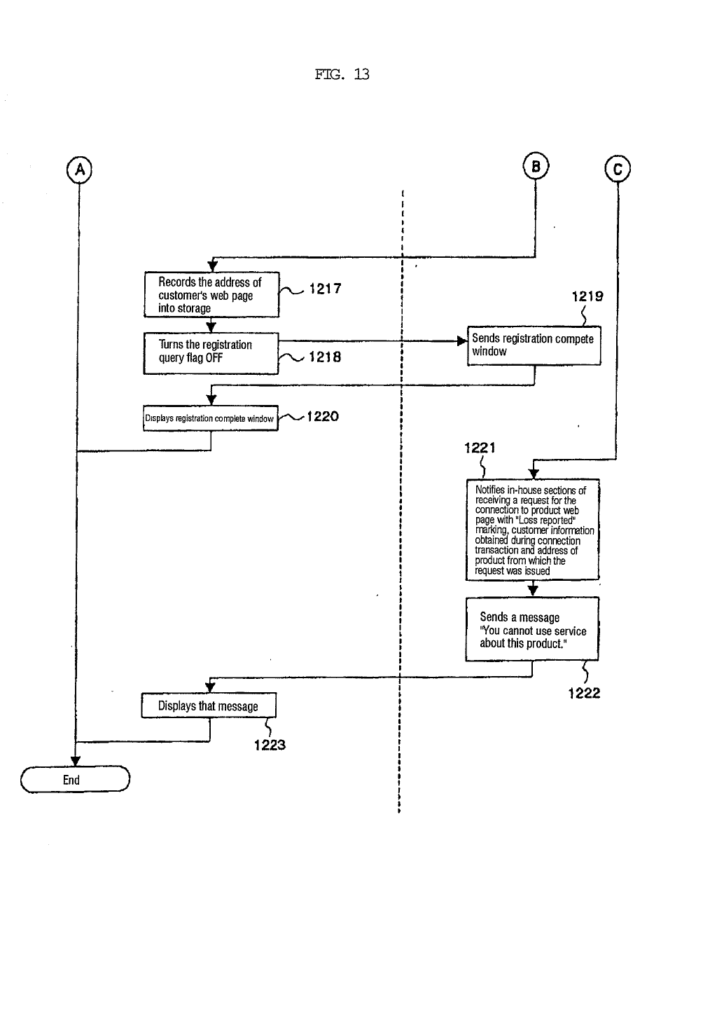

FIG. 12 and FIG. 13 in combination show a flowchart illustrating the detailed procedure of the product owner registration for customer service use to be carried out between the customer and the supplier-proprietary information service equipment 15, wherein the customer may get the product from someone else or in a dishonest manner. This procedure will be explained below.

(1) After the power-on of the user equipment (product), the initial procedure is performed in the same way as explained in the steps 601 to 612 in FIG. 6 up to the phase that the server-side information service equipment creates the customer's private web page in the customer DB and the user equipment reads the address of the discrete product web page from its storage, sends it, and accesses that page (steps 1201 to 1212).

(2) When the discrete product web page is accessed, the server-side equipment checks to see whether the “Loss reported” is marked on that page (step 1213). If “Loss reported” is not marked, the server-side equipment judges that the product user justifiably gets the product and executes the same processing as explained in the steps 613 to 619 in FIG. 6; it interlinks the customer's private web page with the discrete product web page and executes other processing for the registration for service (steps 1214 to 1220).

(3) If, by the check in the step 1213, the “Loss reported” marking on the discrete product page is detected, the server-side equipment judges that the product user dishonestly gets the product that is accessing the product web page. The equipment notifies the supplier in-house sections involved of receiving a request for the connection to the product web page with “Loss reported” marking, customer information obtained during the connection transaction, and the address of the product from which the request was issued (step 1221).

(4) Furthermore, the server-side equipment sends a message “You cannot use service about this product” to the user equipment (step 1222). The user equipment displays this message received on its display screen, when the transaction terminates (step 1223).

What is claimed is:

1. A customer service method that builds a customer service system in which information service equipment to retain customer service information such as product information offers said customer service information to customer-side equipment when said customer-side equipment connects thereto via a communications line and requests information service offering; comprising
preparing said customer-side equipment, prior to being supplied to a customer, in condition that the address of said information service equipment is stored into its storage, and it is furnished with a means to read the address from said storage and make the connection to said information service equipment as requested by the user thereof.

2. The customer service method according to claim 1, wherein:
said customer-side equipment is furnished with a means of displaying a dialog window that asks whether the user thereof wants to connect to said information service equipment as soon as it is powered on, prior to being supplied to a customer.

3. The customer service method according to claim 2, wherein:
said information service equipment creates a customer's web page as required by said customer-side equipment and sends the address of the created customer's web page to said customer-side equipment.

4. The customer service method according to claim 3, wherein:
said information service equipment keeps said customer's web page linked to product data on said customer-side equipment.

5. The customer service method according to claim 4, wherein:
said information service equipment, after receiving the address of the web page of a product other than said customer-side equipment from customer-side equipment to which the address of said customer's web page has been sent, links said customer's web page to the web page for offering the information about that product.

6. A customer service method that operates a server to offer customer service information to customer-side equipment when said customer-side equipment connects to said server and requests service offering; comprising:
creating a customer's web page linked to a web page for offering product information on said customer-side equipment, based on the information received from said customer-side equipment; and
notifying said customer-side equipment of the address of said customer's web page.

7. The customer service method according to claim 6, wherein:
after the reception of the address of the web page of a product other than said customer-side equipment from customer-side equipment to which the address of said customer's web page has been sent, said customer's web page is linked to the web page for offering the information about that product.

8. The customer service method according to claim 6, wherein:
personal authentication data is stored into said server and the access to said customer's web page is permitted after the completion of customer authentication using said personal authentication data.

9. The customer service method according to claim 7, wherein:
upon the reception of the customer's request to remove the owner registration of a product, the link from said customer's web page to the web page of the product is disconnected.

10. The customer service method according to claim 6, wherein:
said web page for offering the information about the product is created as a discrete product web page assigned to a product owned by the customer.

11. The customer service method according to claim 10, wherein:
upon the reception of the customer's request to remove the owner registration of a product, the link from said customer's web page to the web page of the product is disconnected and the information that the owner of the product is undefined is added to said discrete product web page.

12. The customer service method according to claim 10, wherein:
after the reception of the customer's notification of loss of the product, the information that the product has been lost is added to said discrete product web page.

13. The customer service method according to claim 12, wherein:
when the access to the discrete product web page with the addition of said information that the product has been lost, it is reported to the predetermined in-house sections of the supplier.

14. An information processing equipment comprising:
an input interface for allowing the user to input data;
a processor for processing the input data;
storage for storing software to be executed by the processor;
a display for presenting visible data; and
a communications interface for communication over a network,
wherein the address of a server to offer product information about said information processing equipment for connection over said network is stored into said storage, prior to the supply of said information processing equipment to a user.

15. The information processing equipment according to claim 14, wherein:
a guidance dialog window that asks whether the user wants to make the connection to said server to offer information is shown on said display as soon as said information processing equipment is powered on.

16. The information processing equipment according to claim 15, wherein:
upon the reception of the request for the connection to said server to offer product information from said input interface, said processor reads said address of the server from said storage and attempts to connect to said server via said communications interface.

17. The information processing equipment according to claim 14, further comprising:
a means of displaying an input guidance window to prompt the user to input data for creating a customer's web page; based on the data said server creates the customer's web page after the connection thereto is established.

18. The information processing equipment according to claim 14, wherein:
said storage is to retain the data for authentication to be required when connecting to said server to offer product information.

19. The information processing equipment according to claim 14, further comprising:
a means to set said processor to make or not to make the display of the guidance dialog window that asks whether the user wants to make the connection to said server to offer information as soon as said information processing equipment is powered on.

20. A server to offer customer service information when customer-side equipment connects thereto via a communications line and requests service offering, comprising:
a means of creating a customer's web page and linking this page to a web page for offering product information about said customer-side equipment, based on the information received from said customer-side equipment; and
a means of notifying said customer-side equipment of the address of said customer's web page.

21. The server according to claim 20, further comprising:
a means of linking said customer's web page to a web page for offering product information about another product after said server receives the address of said web page of that product other than said customer-side equipment from the customer-side equipment to which the address of said customer's web page has been sent.

22. The server according to claim 20, wherein:
data for personal authentication is stored into said server and said server includes a means of customer authentication using said data for personal authentication whenever said customer's web page is accessed; thus, the access is permitted only after the completion of said customer authentication.

23. A program executable on a server to offer customer service information when customer-side equipment connects thereto via a communications line and requests service offering, comprising:
a step of creating a customer's web page and linking this page to a web page for offering product information about said customer-side equipment, based on the information received from said customer-side equipment; and
a step of notifying said customer-side equipment of the address of said customer's web page.

24. The program according to claim 23, further comprising:
a step of linking said customer's web page to a web page for offering product information about another product when said server receives the address of said web page of that product other than said customer-side equipment from the customer-side equipment to which the address of said customer's web page has been sent.

25. The program according to claim 24, further comprising:
a step of disconnecting the link from said customer's web page to the web page of a product when said server receives the customer's request to remove the owner registration of the product.

26. A customer service method that operates a server to offer customer service information to customer-side equipment when said customer-side equipment connects to said server and requests service offering; comprising:
storing customer information that links to the web page for offering product information about said customer-side equipment with the link being distinguishable by the identification data of a customer;
notifying said customer-side equipment of access key data for accessing said customer information; and
offering said customer information to said customer when said customer accesses customer information in accordance to said access key data.

27. The customer service method according to claim 26, wherein:
after the reception of the address of the web page of a product other than said customer-side equipment from customer-side equipment to which said access key data has been sent, said customer information is linked to the web page for offering product information about that product.

28. The customer service method according to claim 27, wherein:
upon the reception of the customer's request to remove the owner registration of a product, the link from said customer information to the web page of the product is disconnected and related data is deleted.
